(19) United States
(12) Patent Application Publication
(10) Pub. No.: US 2006/0239657 A1
(43) Pub. Date: Oct. 26, 2006

(54) Dedicated digital media for playing of music and video content

(76) Inventors: Amir Geva, Hertzelia (IL); Rafi Mosseri, Ramat Gan (IL)

Correspondence Address: Rafi Mosseri, 40 Moria St, Ramat Gan, 52381, IL

(21) Appl. No.: 11/318,699

(22) Filed: Dec. 28, 2005

Related U.S. Application Data
(60) Provisional application No. 60/669,377, filed on Apr. 8, 2005.

(51) Int. Cl. H04N 7/26

(52) U.S. Cl. 386/112

(57) ABSTRACT

Self-contained apparatus for storing, distributing, and playing of digital content. The present invention is of a media for commercial distribution of music and video, which is also capable of playing the digital content stored therein, thus eliminating the need for a separate player. This enables copyright owners to distribute digital copies of their original work in a safe and cost-effective way. Media according to the present invention contains a single legal copy of the content in compressed digital format for lifetime replay, but output is analog only and does not enable a digital copy of the content. There is added convenience for the consumer, who needs only the media instead of both the media and a player. The apparatus can be connected directly to headphones or to an amplifying device or PC. Video versions of the present invention can be connected directly to a television set.

The present application claims benefit of U.S. Provisional Patent Application No. 60/669,377 filed Apr. 8, 2005.

### FIELD OF THE INVENTION

The present invention relates to active electronic digital media, and, more particularly, to media storing digital content and containing embedded dedicated playback apparatus for playing the digital content.

### BACKGROUND OF THE INVENTION

There is an increasing need to be able to distribute proprietary digital content (such as copyrighted material) in a safe and secure manner, free of the risk of unauthorized copying. Unauthorized copying is a serious problem in the distribution of digital media having openly-readable content (e.g., optical disks). Openly-readable content is generally vulnerable to being copied without authorization, in violation of the copyright.

Various solutions to the security problem have been proposed for digital media, including embedded cryptographic capabilities, such as found in the “Secure Digital” (SD) replaceable media solution. Unfortunately, solutions such as SD are complex and expensive to implement, and require the development of secure media players to access the encrypted digital content. Moreover, the user has to purchase a special player, which is often expensive. Furthermore, although the separate player is authenticated by the media, the need for a separate device in the playback process increases the vulnerability of the media to attack and compromises the security of the digital content encryption.

There is thus a need for, and it would be highly advantageous to have, a secure digital media that protects the content therein without requiring the user to purchase separate special playback apparatus. This goal is achieved by the present invention.

### SUMMARY OF THE INVENTION

The present invention is of a new digital media for music and video content, which protects the content from unauthorized copying, but which contains dedicated playback apparatus, and therefore does not require the user to purchase separate special playback apparatus. “Dedicated digital media playing devices” according to the present invention do not output any digital information. Only analog signals are output. The analog signals output are satisfactory for actual playback but are not in digital form for unauthorized copying. The user can thereby purchase a legal copy of the protected digital content, but cannot make digital copies thereof. Moreover, the end-user cost of the content and the playback apparatus is comparable to the cost of purchasing prior-art media-only copies of the content.

A novel feature of the media according to the present invention is the inclusion of dedicated digital playback circuitry capable of playing back analog conversions of the embedded digital content without requiring an external playing device. Using the media according to the present invention, both the consumer (end user) and the content provider (e.g. the record companies or publishers) enjoy increased advantage over existing prior-art media, such as magnetic or optical media. Protection of the digital content is of the same level as protection afforded by “Secure Digital” devices, but does not require the user to purchase a separate playback device. Moreover, the content owner does not have to license or use expensive cryptographic solutions to attain the desired level of protection of the digital content.

A primary objective of the present invention is to provide a new media for distribution of music and video content to the end user.

An objective of the present invention is to provide a low cost digital storage and playing system for any music/video content.

Another objective of the present invention is to provide a compact and mobile device for music/video streaming.

Another objective of the present invention is to provide a combined solution for music/video media storage and the playing component.

Another objective of the present invention is to help the content owners and publishers prevent illegal use/copy of their intellectual property, which is liable to be distributed by shared media platforms (e.g. Internet) and duplicated by consumer products (e.g. MP3 players, CD/DVD writers).

Another objective of the present invention is to provide an effective and innovative technology to decode and play a digital music/video file burned in local memory.

Another objective of the present invention is to provide an alternative to the illegal distribution of music and video content by presenting an approach that enables the end-user to obtain the content in a low price, while saving the high cost of the playing device.

The typical end user of products according to the present invention is a private consumer, such as a consumer in the present CD music market or DVD/VHS video market.

The projected sponsors and distribution channels for the present invention are typically record companies, production houses, film producers, broadcasters, and music/video retailing/rental chains and stores.

It is emphasized that the present invention is limited to the storage and playback of content in a digital format which is capable of reproducing recorded aural and visual sources. The present invention does not apply to the playback of computer-generated audio and/or video, or formats therefor, including, but not limited to MIDI (Musical Instrument Digital Interface), synthesized speech, and similar streams.

Accordingly, the term “recorded digital content” herein denotes any audio and/or video material in digital format, at least a portion of which was recorded from real aural and/or visual sources. The term “embedded pre-recorded digital content” with respect to a commercially-available device denotes recorded digital content that is embedded (also denoted as “pre-loaded”) into that device prior to the delivery of the device to a user or customer; according to a non-limiting embodiment of the present invention, the embedding of the recorded digital content into the device is done during the manufacture of the device; according to another non-limiting embodiment of the present invention, the embedding of the recorded digital content into the device is done after the manufacture of the device during a configuration operation prior to delivery of the device to the user or customer. Both these cases are herein denoted by the term “substantially at the time of manufacture”.

The term “real aural source” herein denotes any physical phenomenon which can be heard by the aided or unaided human ear, including, but not limited to: speech; music; sounds produced by nature; and sound effects. The term “real visual source” herein denotes any object or physical phenomenon which can be seen by the aided or unaided human eye. The terms “record”, “recorded”, and “recording” herein respectively denote the processing, result, and product of transcribing physical aural and/or visual phenomenon from source into a form suitable for playback thereof. The term “digital format” with respect to recordings and recording processes herein denotes any digital data in a format suitable for the recording of transcribed physical aural and/or visual phenomenon. The terms “video recording” and “recorded digital video content” herein denote any recording, at least a portion of which is a recording of a real visual source, containing at least one image, which may be static (e.g., “graphics”, “still picture”) or dynamic (e.g., “motion picture”). The term “player” herein denotes a device which can play back recorded digital content. Players can play back recorded audio material and/or recorded video material.

The present invention is of a device that serves as a new medium for distribution of commercial music and video content. An advantage to the user is that there is no need for a separate player, because a device according to the present invention both stores and plays the music and/or video, thereby enabling the content owners and publishers to distribute digital copies of their original work of art in a safe and cost-effective manner.

Instead of having two components in order to play the music or video (e.g. CD +CD player) or illegal copy of music/video files to players devices (e.g. MP3 players) a device according to embodiments of the present invention includes a single legal copy of a music/video set of tracks (similar to a music CD content) for a lifetime of replays. A device according to an embodiment of the present invention can be connected directly to headphones, earphones, or to any other amplifying device or PC. Output is Analog and does not enable a digital copy of the content. For playing of video content, a device according to the present invention can be connected directly to a television and/or to an amplifying audio system. In another embodiment of the present invention, the analog output is transmitted wirelessly to such devices, by means including, but not limited to: infrared; and radio frequency, such as FM radio.

Purpose of the Present Invention

The general purpose of the present invention is to provide a new digital media for music and video content in a legal distribution method that conforms with and upholds copyright laws. Using media according to the present invention, both the consumer (end user) and the content provider (e.g. the record companies) enjoy many more advantages than with prior-art media (e.g., CD, DVD, MP3 players, Video/Audio cassette, and minidisks).

The present invention enables record companies and other content owners/providers to distribute legal digital copies of their content, while fully-protecting the digital content. For the consumer, buying a single instance of a device according to the present invention is equivalent to buying a single copy of the content, similar buying a music CD or a video DVD. The present invention aids the content provider in preventing the distribution of illegal copies of the content by presenting consumers with a cost-effective alternative for obtaining a digital copy of the content and a playing system at the same time.

The present invention also enables the consumer to enjoy high-quality reproduction of the content at a low price, in the range of an average price of a music CD or video DVD. The device according to the present invention saves time and requires no loading of any content on a general playback device (e.g. MP3 player), and furthermore saves the cost and space of the playing system (e.g. DVD player, CD player).

The present invention discourages illegal copying by not outputting any digital signals or digital data. Only analog signals are output. Analog signals can always be copied freely by the user, but do not possess the quality, freedom from noise, and multi-generational copying capabilities inherent in digital copies.

Technical Overview

A device according to the present invention a light-weight and compact device varying in size from that of a credit card to a CD size (but slightly thicker), and equipped with a small battery. The core technology of the present invention relies on a single processing chip that includes the decompressing and playing circuit, and a ROM/non-volatile memory chip with the embedded pre-recorded content. In an embodiment of the present invention, the two are combined into the same chip. Peripheral components include, but are not limited to, controls, audio/video connectors, D/A converters, optional screen for display, and an optional description mechanism.

Therefore, according to the present invention there is provided a device for storing and playing embedded pre-recorded digital content, the device including: (a) a non-removable memory unit for storing the pre-recorded digital content, and wherein the pre-recorded digital content is recorded in the memory unit substantially at the time of manufacture; (b) a processor for retrieving the recorded digital content from the memory unit and converting the digital content to a playable digital signal; (c) a digital-to-analog converter for converting the playable digital signal to an analog output for playing; and (d) an analog output connector for connecting the analog output to an external signal transducer; wherein the device outputs only analog output and does not output digital signals corresponding to the embedded pre-recorded digital content.

### BRIEF DESCRIPTION OF THE DRAWINGS

The invention is herein described, by way of example only, with reference to the accompanying drawings, wherein:

FIG. 1 is a conceptual block diagram of a dedicated digital media playing device according to an embodiment of the present invention.

FIG. 2 is a data flow diagram of an audio/video stream output by a dedicated digital media playing device according to an embodiment of the present invention.

FIG. 3 conceptually illustrates the basic control flow from a user's perspective of a dedicated digital media playing device according to an embodiment of the present invention.

FIG. 4 conceptually illustrates a configuration of a dedicated digital media playing device in a home (or similar) environment according to an embodiment of the present invention.

FIG. 5 conceptually illustrates a configuration of a dedicated digital media is playing device in a personal mobile environment according to another embodiment of the present invention.

### DESCRIPTION OF THE PREFERRED EMBODIMENTS

The principles and operation of a dedicated digital media and playback device according to the present invention may be understood with reference to the drawings and the accompanying description.

Main Core Components and Technology

FIG. 1 is a conceptual block diagram of a dedicated digital media playing device 100 according to an embodiment of the present invention. Central to operation is a memory 101 which contains embedded pre-recorded digital content which can be played by dedicated digital media playing device 100. Memory 101 can be any non-volatile machine-readable memory, including, but not limited to: Read-Only Memory (ROM); Programmable ROM (PROM); One-Time Programmable (OTP) memory; Electrically-Programmable ROM (EPROM); Electrically-Erasable PROM (EEPROM); flash memory; NOR and NAND-based memory. In certain embodiments of the present invention, the pre-recorded digital content is encrypted. A processor 103 handles the reading of the pre-recorded digital content, the decoding thereof, and for embodiments of the present invention wherein the pre-recorded content is encrypted, processor 103 also handles the decryption. In other embodiments of the present invention, the pre-recorded digital content is not encrypted.

In certain embodiments of the present invention, memory 101 containing digital content for the device is non-removable. The term “non-removable” herein denotes that the device has no provision for the user to alter, remove, or replace the content-containing memory, nor does the device have any provision for the user to install different content-containing memory.

In a preferred embodiment of the present invention, proprietary pre-recorded digital content is embedded in memory 101 with the consent and agreement of the owner of the proprietary rights thereof. Preferred embodiments of the present invention provide for the pre-recorded digital content to be recorded in formats including, but not limited to: MP3; WMA, AAC; MPEG; and MPEG-4 AVC.

For audio content, an audio digital-to-analog converter 105 converts the digital representations of audio signals to an analog audio signal, which is fed to an audio amplifier 107, whose output is delivered externally via an audio output connector 109. An audio volume control 125 allows the user to adjust the audio volume to the desired level. In embodiments of the present invention, volume control 125 is a wheel or slide that the user can move to adjust the analog output signal strength. In other embodiments of the present invention, volume control 125 is a push-button that can be pressed to adjust the analog output signal strength. Likewise, for video content, a video digital-to-analog converter 111 converts the digital representation of video signals to an analog video signal. In an embodiment of the present invention, the analog output is fed to a video driver 113. The output is delivered externally via a video output connector 115. In certain embodiments of the present invention, a wireless transmitter 117 is used for analog signal output to external devices.

In embodiments of the present invention, additional controls provided for the user include, but are not limited to: a stop/play button 119; a skip/run backward button 121; and a skip/run forward button 123. According to preferred embodiments of the present invention, user operation of these controls is monitored and effected by processor 103 having suitable software (including “firmware”) for such monitoring and effecting.

A dedicated digital media playing device according to embodiments of the present invention also features an internal battery for electrical power. Additional embodiments of the present invention provide for an AC power adapter and a receptacle for external power.

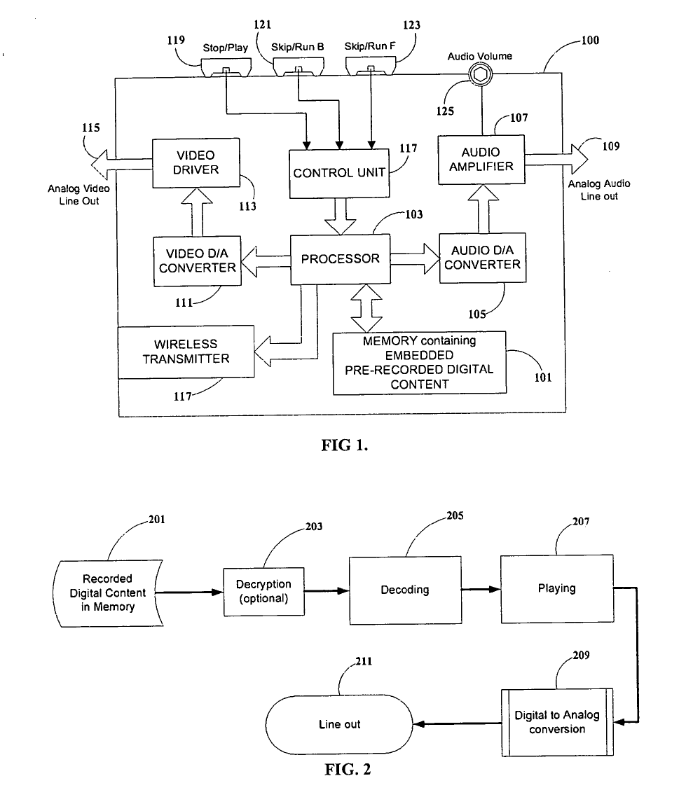

FIG. 2 illustrates the basic data flow in a dedicated digital media playing device according to embodiments of the present invention. Data flow starts with recorded digital content 201, which is embedded in memory 101 (FIG. 1). This is read from by processor 103 and optionally decrypted at a point 203 (for those embodiments of the present invention in which the data is encrypted). At a point 205 the digital data is decoded, and at a point 207 the content is played as a digital stream. Finally, at a point 209 the digital stream is converted to an analog signal, which is output to an analog stream 211. It is once again noted that the content and the output can include audio, video, or a combination of audio and video.

Based on the internal power source (e.g., 1.5v-9v battery) or an external source (AC adapter), manual operation of the user initiates the appropriate action.

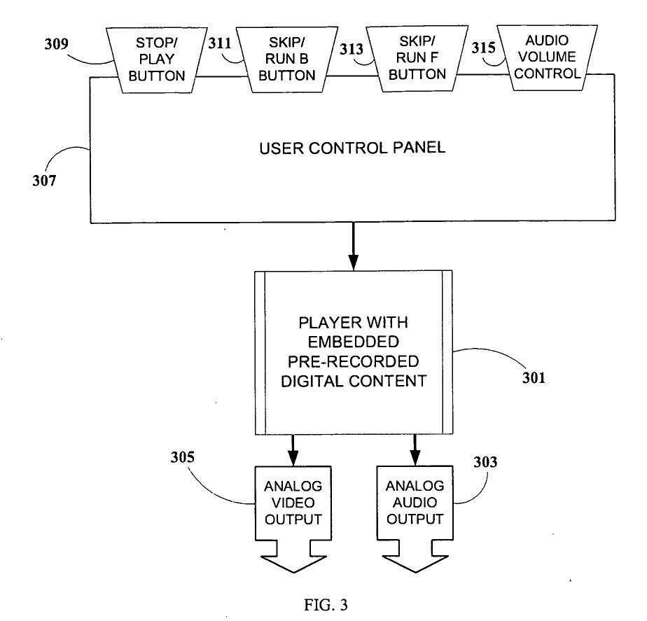

FIG. 3 conceptually illustrates the basic control flow from the perspective of a user of a dedicated digital media playing device 301 according to an embodiment of the present invention. The user desires an audio output 303 and/or a video output 305.

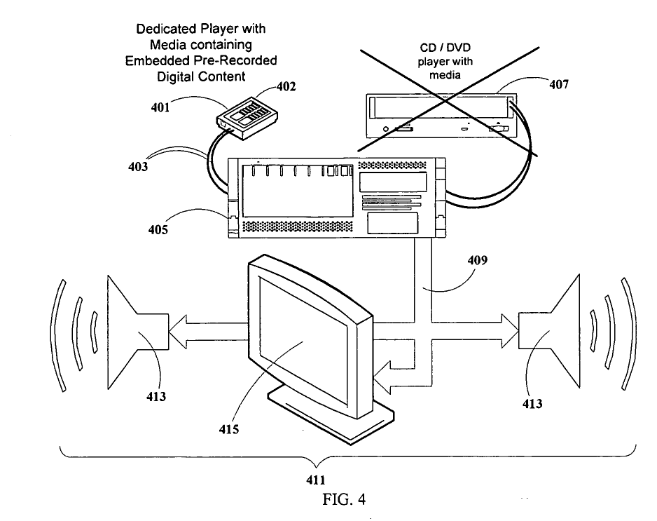

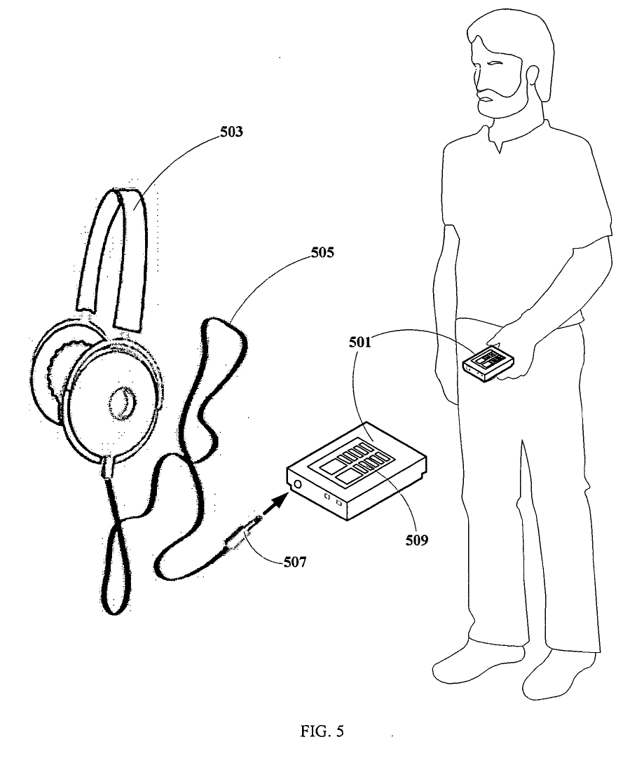

As noted previously, both audio output 303 and video output 305 are in the form of analog signal streams only. Certain embodiments of the present invention output electrical signals only, and exclude all forms of electrical transducers for the embedded pre-recorded digital content. That is, according to various embodiments of the present invention, the device excludes self-contained signal transducing means. The term “signal transducer” herein denotes any component which converts electrical signals derived from the digital content into audible or visible phenomenon, including, but not limited to: speakers; and visual displays. “Signal transducers” exclude devices which convert such electrical signals into non-audible and non-visible signals, including, but not limited to: infrared; and radio frequency. The term “self-contained” with regard to a signal transducer denotes a signal transducer that is an integral part of the device. That is, a device according to certain embodiments of the present invention excluding self-contained signal transducing means does not directly output any sound or images which are part of the embedded pre-recorded digital content. In order to convert the electrical signals output by these embodiments of the present invention into sound and images, the user must connect the dedicated digital media playing device to external apparatus, such as a separate headphone or earphone set, a display, or an entertainment system (as illustrated in FIGS. 4 and 5). This assures optimal quality for sound and image reproduction, and reduces the cost of the dedicated digital media playing device.

In this context, it is noted that meta-information about the pre-recorded digital content (such as track numbers, playing time, title and artist information, and the like) is not considered as content, and various embodiments of the present invention also feature displays which notify the user of the current track that is being played. Content itself, however, does not appear on such displays.

Returning to FIG. 3, the user also has access to a user control panel 307, which includes, but is not limited to the following controls: a stop/play button 309; a skip/run backward button 311, a skip/run forward button 313, and an audio volume control 315. Control panel 307 may be distributed in various locations of the device.

Video Application

In another embodiment of the present invention, the digital content is video. The block diagram of FIG. 1 also applies for video, as previously noted. The main difference is that in addition to audio playing capability, this embodiment of the present invention is designed to also play a visual content, such as video or other visual digital data.

Embodiments of the present invention for video use are typically more complicated and costly than those for audio use only. Typically, there is a larger capacity for memory 101 (roughly comparable to the ratio of CD storage capacity to DVD storage capacity), a more powerful processor 103 for the video decoder and player, and video interfaces, including, but not limited to: Composite; S-Video; and VGA) in addition to audio capabilities. FIG. 4 illustrates an example of video output interfaces in an embodiment of the present invention.

Audio/Video CODEC

To save memory space, keep costs low, to achieve high audio/video quality in embodiments according to the present invention, an effective compression technique (CODEC) is needed. Such algorithm/software are currently available commercially (e.g. MP3, WMA, AAC for Audio compression, WMV, MPEG-4 AVC for video compression). In another embodiment of the present invention, a proprietary compression algorithm offers superior data compression and fidelity.

An advantage of the present invention over prior art decoding and playing devices (e.g. CD player, DVD player, MP3 player) is that the merging of the storage medium and the playing medium in a single product enables using any type of audio/video CODEC without a requirement to comply with any interoperability standards or with other products. For example, since all data is preloaded and there is no need to support different (external) players, it is possible to utilize Variable Bit Rate (VBR) compression to reduce memory size.

Decoding and Playing Process

In a preferred embodiment of the present invention, pre-recorded digital content is embedded into a dedicated digital media playing device in a compressed format using offline encoding tools, which are not part of the present invention. This process is part of the currently-available production process and must be done only one time per production of a single item.

After receiving the user's activation command (e.g. ‘Play’ command) a real-time process transforms the stored digital content into analog audio/video signals. Such process should preferably include a real-time decoder system and a real time playing system. The compressed file is read from the internal memory in real time and passes through a decompression mechanism for transformation into clear/uncompressed digital data. From the decoding unit, the data is sent to a real-time player for additional processing that turns the digital data into a music/video signal. The output signal is then converted to an analog signal for playing by an external transducer, non-limiting examples of which include headphones, speakers, amplifier, television, etc. The external transducer is connected to the device via an analog output connector.

FIG. 4 conceptually illustrates a configuration of a dedicated digital media playing device 401 in a home (or similar) environment according to an embodiment of the present invention. On the external package of dedicated digital media playing device 401 is a label 402 or directly printed listing of tracks and other information regarding the device's content. Device 401 is connected via cables 403 to an amplifier or home entertainment unit 405 for playback. It is shown that device 401 replaces CD/DVD player with media 407. Unit 405 outputs an analog audio/video stream 409 to a transducer setup 411, which includes speakers 413 and /or a visual display 415.

FIG. 5 illustrates another embodiment of the present invention, a configuration of a dedicated digital media playing device 501 in a personal mobile environment. Device 501 connects to headphones (or earphones) 503 via a cord 505 whose plug 507 inserts into device 501. In this embodiment, instead of a printed label on device 501, an on-screen display 509 shows the current track number, track name, etc. of the playing content. In still another embodiment of the present invention, both a label (such as label 402 in FIG. 4) and a display (such as 509) are used. It is again noted that track number, track name, titles, names of artists, and so forth, are not considered as content, but rather are treated as meta-data (data about content), and hence the appearance of such information on a display integral with the device does not involve a display of content.

In an embodiment of the present invention, an internal buffering mechanism enables smooth control of the decoding/playing pace.

Low Power Consumption and Cost Reduction

Embodiments of the present invention serve as mobile devices, and therefore these embodiments include only low-power components that can operate by internal batteries, such as the AAA size battery, or watch batteries.

Because there is no need for any writable memory components (e.g. Flash) in devices according to the present invention, it is possible to use variants of ROM technologies, whose cost is much lower than flash memory. In certain embodiments of the present invention all memory is non-alterable memory, and no memory is alterable. The term “non-alterable memory” herein denotes memory for which there is no provision for user modification of the contents of the memory, including, but not limited to flash memory without an input interface. The term “alterable” herein denotes memory which is a provision for user modification. Modification of memory includes, but is not limited to: writing; overwriting; erasing (deleting); and relocating of memory contents.

In addition, instead of using a controller, which is a relatively expensive and power-hungry component, embodiments of the present innovation use low-power and low-cost logic devices. Another saving both in cost and power is the on-screen display for meta-data, which, in embodiments of the present invention, are minimal. In other embodiments of the present invention, the on-screen display is omitted.

User interface

The present innovation does not require any loading of audio/video/data tracks to the local memory of the device. Furthermore, the set of tracks is typically limited to a few dozen at most, and thus, the user interface is simpler than in typical prior art playing devices that must handle a variety and changeable set of tracks (e.g. MP3 players, DVD/CD players). Embodiments of the present invention feature only a very simple and basic screen display; other embodiments of the present invention omit the screen display altogether. Alternatively, advanced embodiments of the present invention include additional functions that are operated from the on-screen display.

Simplicity of Operation

Another objective of the present invention is to simplify the playing and storage of digital music and video content. A unified system that merges both music and video entities into a single, simple and price-wise product also reduces the complexity of usage of typical electronic devices and therefore reduces the reluctance of the user to adopt such devices.

There are a number of functions required for prior-art players that are not necessary in embodiments of the present invention, and whose elimination therefore eases restrictions on embodiments of the present invention. These omitted functions include, but are not limited to:
loading tracks from an external source—a dedicated digital media playing device according to various embodiments of the present invention lacks (or excludes) means for signal input;
outputting tracks in digital format to an external receiver;
selecting track order in the local storage;
selecting the track to play; and
deleting tracks for freeing memory space.
   Advanced Versions

Embodiments of advanced versions of the present invention are more expensive but include more features than the basic common versions. Such features include, but are not limited to:
Advanced Audio/Video interfaces and control options:
AC3 Audio interface
High definition resolutions
Dolby filters
Equalizer
Remote control
On screen display
Data of each track
Bluetooth interface
   Control and Monitoring

Basic operations according to embodiments of the present invention are operated manually by user commands supported on the cover. Controls are implemented by means including, but not limited to: buttons; movable slides; and movable wheels.
Play
Stop
Skip forward
Skip backward
Run forward
Run backward.

The above are classified as “play controls”, a term herein denoting any control which governs the play of the device. In addition, embodiments of the present invention have additional controls for adjusting analog output signals:
Volume up
Volume down
Tone up (optional)
Tone down (optional)
Balance R/L (optional)

Volume controls are for adjusting analog output signal strength, and tone controls are for adjusting analog output signal frequency response. Balance controls are for adjusting stereo analog output signal strength.

In embodiments of the present invention which include a screen display, many more control and monitoring functions are possible.

While the invention has been described with respect to a limited number of embodiments, it will be appreciated that many variations, modifications and other applications of the invention may be made.

1. A device for storing and playing embedded pre-recorded digital content, the device comprising:
a non-removable memory unit for storing the pre-recorded digital content, and wherein the pre-recorded digital content is recorded in said memory unit substantially at the time of manufacture;
a processor for retrieving the recorded digital content from said memory unit and converting the digital content to a playable digital signal;
a digital-to-analog converter for converting said playable digital signal to an analog output for playing; and
an analog output connector for connecting said analog output to an external signal transducer;
wherein the device outputs only analog output and does not output digital signals corresponding to the embedded pre-recorded digital content.

2. The device of claim 1 further excluding signal input means.

3. The device of claim 1, wherein said memory unit for storing the pre-recorded digital content is non-alterable memory.

4. The device of claim 1, wherein the digital content is selected from the group consisting of: aural content and visual content.

5. The device of claim 1 further comprising at least one of the following:
a play-control, for controlling play;
a volume control, for adjusting analog output signal strength;
a balance control, for adjusting stereo analog output signal strength;
a tone control, for adjusting the analog output signal frequency response; and
a wireless transmitter, for sending an analog output signal to an external device.

6. The device of claim 1 further excluding self-contained signal transducing means.
